(19) United States
(12) Patent Application Publication
(10) Pub. No.: US 2024/0101883 A1
(43) Pub. Date: Mar. 28, 2024

(54) DUST SUPPRESSION RESIN AND RESIN USE

(71) Applicants: Vale S.A., Rio de Janeiro (BR); Universidade Federal Do Espirito Santo - UFES, Vitória (BR)

(72) Inventors: Renata Eline Frank VASCONCELOS, Vitória (BR); Eloi Alves da SILVA FILHO, Vitória (BR); Carlos Vital Paixão de MELO, Vitória (BR)

(21) Appl. No.: 18/475,096

(22) Filed: Sep. 26, 2023

(30) Foreign Application Priority Data
Sep. 26, 2022 (BR) BR132022019265-0

(51) Int. Cl. C09K 3/22

(52) U.S. Cl. CPC C09K 3/22

(57) ABSTRACT

The described aspects relate to a dust suppression resin, and a method of obtaining the dust suppression resin through the chemical recycling of thermoplastic polymer Poly(Ethylene Terephthalate) or PET. The method for obtaining the resin includes a depolymerization reaction applied to the Poly(Ethylene Terephthalate) polymer, such as post-consumer PET fragments, in the presence of the quaternary ammonium cationic surfactant. The method further includes subsequently adding a hydrophilic substance to increase a final viscosity of the resin. Other additives such as lignin extracted from vegetables, such as leaves and branches of trees, can also be added to make the resin more hydrophobic.

### CROSS REFERENCE TO RELATED APPLICATIONS

This application claims benefit of and priority to Brazilian Patent Application BR 132022019265-0, filed Sep. 26, 2022, which is incorporated by reference herein in its entirety.

### BACKGROUND

The mining industry is of great importance to the economy of many countries. According to the knowledge common to the prior art, ores are marketed (especially iron ore) in their natural form or tablets, such as, for instance, pellets. In the second case, before being transported, these pellets are subjected to heat treatment in the kilns of factories and only then are they handled, packaged, and transported. Although this procedure is regularly used, it is common knowledge that there are many disadvantages arising from such production process, including the formation of large amounts of fine particles, or ore dust, or ore particulates, owing to the constant friction between pellets.

This ore dust is released into the environment and ends up reaching the facilities of ports and communities that are close to ports or factories, in cities where ore mining and pelletizing processes play a relevant economic role. The emission of these particulates causes, in addition to health issues, disturbances to the daily lives of surrounding communities' residents and environmental problems.

Several particulate emission inhibitors have already been described by the prior art, such as water, polymers, mineral oils, and alcohol derivatives. However, developing efficient, environmentally sustainable, and economically feasible dust suppressants remains a current challenge.

Polyethylene terephthalate is a thermoplastic polymer that is part of a category of polymers that contain the ester functional group in its main chain, called polyesters. It is widely used in manufacturing plastic packaging, mainly for beverages, owing to its high transparency and resistance. In recent years, the demand for these plastics has grown significantly, which results in two major potential problems in the PET production chain. The first of these problems refers to the origin of the feedstock for the production of PET, given that, like all polymers, polyesters are made of materials derived from the refining and reforming of oil (petrochemical feedstock), with such feedstock having the impacts of high cost and the fact that its origin is from a non-renewable source. The second problem is the environmental one and refers to the disposal of products made from PET, especially bottles and other plastic utensils that become serious pollution agents, as they are produced and discarded in huge quantities. Disposal of plastic waste is a chronic worldwide problem. Thus, economic, environmental, and sustainability motives mobilize the search for improvements and innovations pertaining to PET recycling and the use of its byproducts. Patent No. BR102014029870-3 surprisingly reveals that it is possible to obtain a dust suppression resin using byproducts of plastic recycling, especially post-consumer PET (PETpc).

Some recycling processes of plastics, or polymeric materials, are known from the prior art, and are intended for the reuse of these materials and their decomposition, with a view to obtaining recycled feedstock that can feed back the polymer manufacturing production chain or be used for other commercial purposes.

There are specific recycling methodologies for each type of polymeric material. In general, the separation of plastics starts the recycling process. It should be carried out considering the physical properties of polymers, such as density, thermal conductivity, softening temperature, among other properties.

The classification of plastics is made pursuant to the types of transformations required for recycling, which are defined in four types: primary or pre-consumer, intended for the reuse of industrial polymeric waste and obtaining products with characteristics equivalent to those of the original products; secondary or post-consumer, intended for the transformation of polymeric waste from urban solid waste and obtaining products that have a lower requirement than the virgin polymer and that are used in the production of other materials; tertiary, also known as chemical recycling, involving the production of chemical inputs or fuels from polymeric waste and where post-consumer plastics are transformed into monomers and reused in the production of new plastics with a quality similar to that of the original polymer; and, lastly, quaternary recycling, also known as energy recycling, where energy recovery from polymeric waste occurs via controlled incineration. In addition to these types of recycling, there is also mechanical recycling, which is carried out through the reprocessing of plastics by extrusion, obtaining polymeric material transformed into pellets (plastic grains).

In the case of post-consumer PET plastics, the main type of transformation currently used for their decomposition is tertiary or chemical recycling, also known as depolymerization or chemical decomposition. Chemical decomposition of PET is based on the reversibility of the polymerization reaction and can be performed by the chemical processes of hydrolysis, glycolysis, methanolysis, and aminolysis, and can be catalyzed by acids, bases, or neutral catalysts.

Through hydrolysis, PET is depolymerized into its monomers, terephthalic acid and ethylene glycol. After purification, these materials can be used for repolymerization or other commercial purposes, allowing savings and reducing the demand for oil byproducts, which are non-renewable feedstock.

Some studies in the literature use only sodium hydroxide and methanol solutions in the depolymerization reaction, and other studies use zinc acetate as a catalyst. In general, the processes are characterized by a long average reaction time, from three to six hours, which accounts for a high energy cost.

Patent No. BR102014029870-3 reveals that the use of cationic surfactants in the process of obtaining dust suppression resin from the chemical decomposition of PET has shown surprising results in relation to the characteristics of the process and the end product obtained. In the present disclosure, promising results were also obtained using, preferably, quaternary ammonium, as a cationic surfactant.

The review article by Daniel Paszun and Tadeusz Spychaj [Ind. Eng. Chem. Res. 1997, vol. 36, p. 1373-1383, 1997] presents the advances in PET recycling that started in the 1980s. Such advances were important to reduce process costs. However, other catalysts are also referred to, but no process used surfactants as a catalyst.

SOUZA et. al., seeking to optimize PET depolymerization process, made use of the anionic surfactant sodium dodecyl sulfate (SDS) and non-ionic surfactants of the Tween™ type (polyethoxylated sorbitan esters derived from fatty acids), seeking to increase the efficiency of the chemical recycling of PET through hydrolysis in basic medium, aiming at obtaining terephthalic acid for repolymerization purposes [SOUZA, L.; TORRES, M. C. M.; RUVOLO FILHO, A. C. Despolimerização do Poli(Tereftalato de Etileno)_PET: Efeitos de Tensoativos e Excesso de Solução Alcalina. Polímeros: Ciência e Tecnologia, vol. 18, No. 4, p. 334-341, 2008]. The observed result was that the use of surfactants did not yield increased efficacy of the process and still added impurities to the recovered terephthalic acid.

The previously presented processes for the depolymerization of PET caused the inconvenience of demanding long reaction periods and high energy consumption to obtain terephthalic acid and ethylene glycol as the end product, which wound up demanding a significant cost in the recycling chain.

Brazilian patent No. PI0200325, for example, describes obtaining terephthalic acid by means of chemical recycling of PET performed from a reaction of the polymer with sodium hydroxide, under a maximum pressure of 15 atm and temperature of up to 198° C., obtained with a heating rate between 15 and 25° C./min. At the end of the reaction, the reactor is cooled and the disodium terephthalate, solid product of the reaction, is separated by filtration. The disodium terephthalate solution is reacted with sulfuric acid until the pH of the solution reaches 3, when all the terephthalic acid precipitates, requiring filtration, drying, grinding, and sieving.

The invention described in patent application No. BR102013001662-4 describes the post-consumer PET bottle depolymerization reaction using the cationic surfactant hexadecyltrimethylammonium bromide (CTAB) in alkaline hydrolysis, aiming at obtaining the terephthalic acid monomer.

Patent No. BR102014029870-3 discloses a process that, through the use of catalysts and specific reaction conditions, allows the chemical decomposition of PET to be carried out through a fast, efficient, and low-cost methodology to obtain an intermediate resin containing ethylene glycol, and this intermediate resin allows the subsequent obtention of the dust suppression resin of interest.

Surprisingly, in patent No. BR102014029870-3, the chemical decomposition of PET is performed at temperatures lower than those described in the prior art, and there is no need to control the pressure and heating rate. Additionally, the process of the present invention utilizes a simple reaction system that requires only a reflux connector to cool the process during the reaction and prevent volatilization losses of the reactants. Another interesting factor in the present invention is the use of the surfactant CTAB as catalyst and the reduction in depolymerization reaction time.

The relevance of the invention described in patent No. BR102014029870-3 can also be supported by the fact that one tonne of decomposed PET generates 300 liters of ethylene glycol on average.

### SUMMARY

The invention described in patent No. BR102014029870-3 deals with a process of obtaining dust suppression resin through the chemical recycling of thermoplastic polymer PET. The process of the present disclosure uses the depolymerization reaction methodology of the PET polymer obtained mainly from post-consumer PET fragments/residues in the presence of a cationic surfactant, but preferably using quaternary ammonium.

An example aspect of the present disclosure is the sustainable recovery and recycling of polymeric materials in order to obtain a dust suppression resin.

The process described includes the production of an intermediate resin containing ethylene glycol, which is obtained as a product derived from the post-consumer PET chemical recycling process, such resin being used to subsequently obtain a dust suppressant, that is, in order to solve the inconvenience caused by the generation of dust in the logistics process, for instance, transport of ore in wagons.

It is noted that the depolymerization process of patent No. BR102014029870-3, which occurs in the presence of cationic surfactant as a catalyst, in addition to the technical advantages addressed, also allows generating terephthalic acid as a byproduct of PET decomposition, and it should be noted that terephthalic acid has considerable added commercial value after its extraction.

Advantageously, the depolymerization process of the present disclosure is carried out without pH correction of the reaction solution, which does not result in salt formation and, in turn, dispenses with the extraction step with alcohol solvent carried out in patent No. BR102014029870-3.

Another advantage of certain aspects is the obtaining of a commercially feasible product as a result of a recycling process, which stands as a profitable disposal alternative for company and community waste. It should also be noted that, according to the present disclosure, PET can be presented in the form of granules of virgin material, flakes of industrial or post-consumer waste, as well as in the most varied particle sizes and colors. The original PET color is also irrelevant. For example, both green and transparent PET bottles can be used, without prejudice to the reaction time and the quality or purity of the end product. This aspect also contributes to process speed, as no additional PET separation steps are required in relation to its original color.

In addition, certain aspects allow commercial value to be added to the recycling product since the market values of dust suppressant of ores resulting from the process, or even of the intermediate products terephthalic acid and ethylene glycol, are much higher than the market value of the original feedstock (gross polymer mass, mainly PET, from selection and recycling processes without additional processing).

Another advantage of one or more aspects is a contribution to environmental development and sustainability, since the process uses plastic waste as a feedstock and the use of this process also allows the qualification of collectors of recyclable materials (typically unqualified labor) to obtain the feedstock, offering them basic working conditions and income generation.

Another advantage of one or more aspects is that, through the use of the process, it is possible to further the development of the community surrounding large companies and communities that produce large volumes of polymeric waste for disposal, in addition to benefiting communities and cooperatives of waste collectors engaged in selective collection and the recycling chain, through the sale of products derived from recycling and dust suppressant.

Yet another advantage of the process of one or more aspects is the fact that the process is simple to be performed, making it possible to be used by any company that uses bulk material stack yards, such as ore and/or transportation of non-food bulk by railways, especially projects located in remote areas, far from industrial centers, where logistics costs stand as an obstacle to the removal of polymeric waste.

### BRIEF DESCRIPTION OF THE DRAWINGS

FIG. 1 is a representation of the PETpc depolymerization chemical reactions occurring in the process subject matter of patent No. BR102014029870-3, demonstrated without the addition of CTAB (Reaction I) and with the addition of CTAB (Reaction II).

FIG. 2 illustrates the characterization of PET resin by infrared spectroscopy, in transmission mode, according to patent No. BR102014029870-3.

FIG. 3 illustrates the characterization of PET resin by infrared spectroscopy, in transmission mode, according to the present disclosure.

FIG. 4 illustrates the thermal gravimetric analysis (TGA) of the product according to patent No. BR102014029870-3, and the experiments were carried out at a heating rate of 10° C. min⁻¹, in an inert atmosphere of N₂ and oxidant (synthetic air) in a temperature range of 30 to 450° C. FIG. 4(a) refers to TPA and FIG. 4(b) to PETpc.

FIG. 5 illustrates DSC curves for the (a) PETpc and (b) TPA samples, according to patent No. BR102014029870-3.

FIG. 6 illustrates the thermal gravimetric analysis (TGA) of the product according to the present disclosure, the experiments being carried out at a heating rate of 10° C. min⁻¹, in an inert atmosphere of argon and oxidant (synthetic air) in a temperature range of 30 to 800° C.

### DETAILED DESCRIPTION

Patent No. BR102014029870-3, filed on Nov. 28, 2014, and incorporated herein by reference, is used in the technical industries of mining, logistics, non-food solid bulk, and recycling of polymeric materials. More specifically, it concerns a process of obtaining a resin, which may be used as a dust suppressant. The process derives from the chemical recycling of the thermoplastic polymer polyethylene terephthalate (or PET). A method for obtaining dust suppression resin is disclosed, using the depolymerization reaction methodology of the polyethylene terephthalate polymer obtained from post-consumer PET bottles (PETpc) in the presence of a quaternary ammonium cationic surfactant. Also, it describes a process for inhibiting particulate emission through the use of the dust suppression resin as obtained from the process.

The present disclosure deals with a method for obtaining the dust suppression resin, as disclosed in patent No. BR102014029870-3, in which, in order to reduce operating costs, the resin is produced in the absence of pH correction of the reaction solution, so that salt formation does not occur and, in turn, performing extraction with alcoholic solvent is not necessary. Also, the production of the resin of this disclosure is performed under passive cooling (room temperature). The present disclosure also deals with the resin thus obtained and its use.

Aspects of the present disclosure will be expanded upon hereinafter, by way of example and not limitation, since the materials and methods disclosed herein may comprise different details and procedures, without departing from the scope of the invention.

To carry out the invention described in patent No. BR102014029870-3, it is common for post-consumer PET plastic (PETpc) to undergo a preliminary recycling and cleaning process before its depolymerization reaction, such as i) the selection of plastic waste composed of PETpc from selective collection; ii) the removal of parts of materials other than PETpc from plastic waste (such as, for example, top and bottom of bottles); iii) washing; iv) drying; v) grinding and standardization of fragment size.

In an aspect, and in some cases after the cleaning process, the chemical recycling process of PETpc itself of the present disclosure includes: i) depolymerization of (clean) fragments of PETpc in the presence of a cationic surfactant and in an alkaline medium; ii) dilution in water for solubilization of terephthalic acid (TPA) monomer; iii) filtration of the remaining medium containing intermediate resin, residual PETpc and other impurities; iv) submission of the solution obtained from step iii) to a passive cooling process, obtaining the intermediate resin; v) addition of a viscosity-increasing agent to the intermediate resin obtained in step iv), obtaining a dust suppression resin and vi) addition of an agent to increase the hydrophobicity of the dust suppression resin obtained in step v).

Unlike the procedure performed under patent No. BR102014029870-3, according to the present disclosure there is no pH correction of the reaction solution, only dilution in water, aiming at reducing the operational cost of the process with the purchase of acid. As the neutralization step ii) performed under patent No. BR102014029870-3 does not occur in the process of the present disclosure, there is no salt formation and, therefore, there is no need to perform extraction with alcohol solvent according to the present disclosure. Also, step iv) of water evaporation carried out under patent No. BR102014029870-3 is not carried out in the process of this disclosure, instead only a passive cooling (room temperature) of the tank that stores the suppressant resin is carried out.

The cationic surfactant used in step i) is preferably ammonium quaternary.

The depolymerization reaction as described in step i) is carried out from one to three hours, the temperature being maintained within a range from 90 to 110° C.

The viscosity-increasing agent added in step v) is selected from the group consisting of hydrophilic substances.

The hydrophobicity enhancing agent added in step vi) is selected from the group consisting of lignin obtained from vegetables and polyethylene wax, preferably lignin obtained from leaves and branches of trees through extraction with 50% hydroalcoholic mixture. This reagent is related to the stability of the film formed on the suppressant application surface, and the more hydrophobic the resin, the more efficient it will be in suppressing dust.

The resin product may be characterized, in structural terms, as described below.

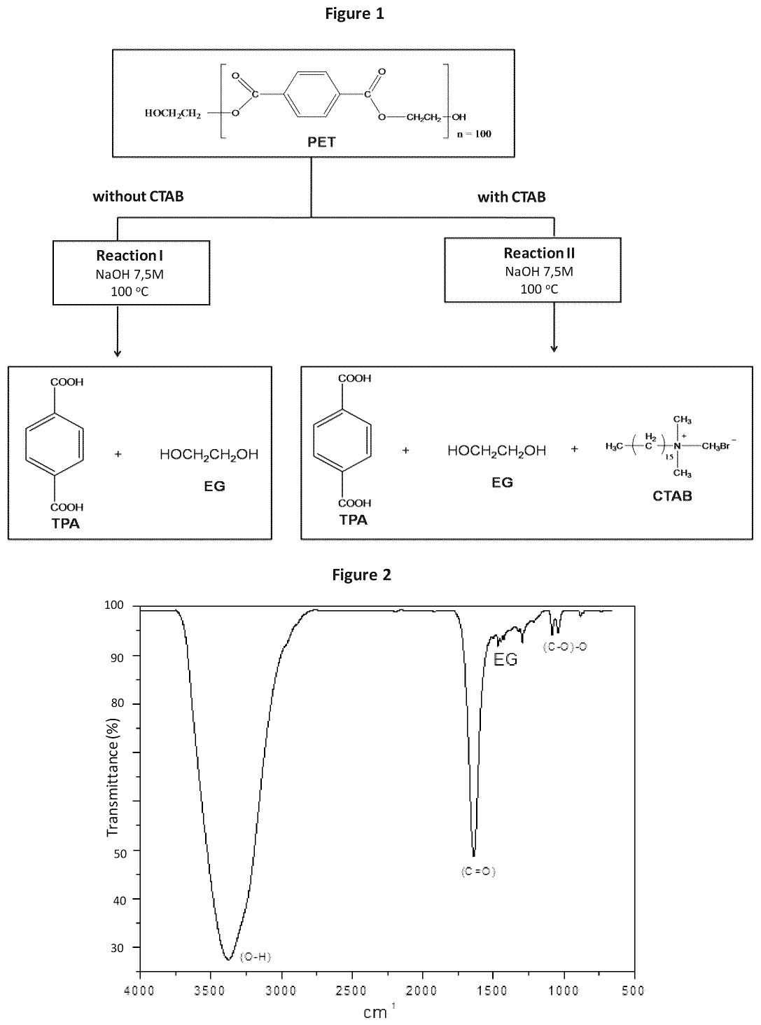

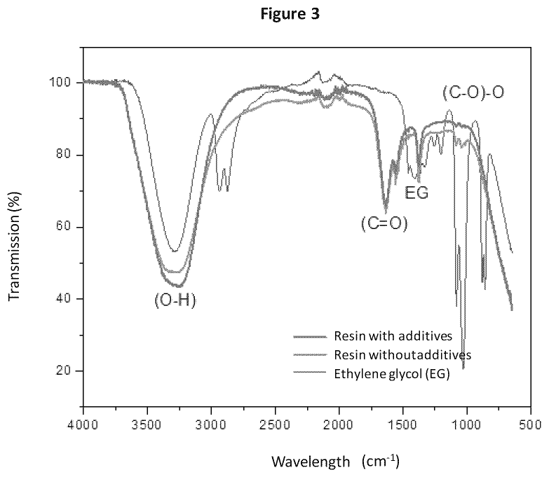

Characterization of PET resin by infrared spectroscopy was performed on an FTIR spectrometer, FTLA 2000-102 (ABB-BOMEM), in transmission mode. Analyses were recorded at 4 cm⁻¹ resolution, in a wavelength range of 4000 to 500 cm⁻¹ and average of 32 scans. The spectrum obtained according to patent No. BR102014029870-3 is shown in FIG. 2, where it was observed that the resin is composed of characteristic functional groups at the five absorption peaks 3373, 1457, 1296, 1075, and 1037 cm⁻¹, respectively. The spectrum obtained according to the present disclosure is shown in FIG. 3.

The assignments of peaks are for axial deformations in the regions of 3373 cm⁻¹ for the O—H group; 1639 cm⁻¹ for the C═O group; 1457 and 1296 for ethylene glycol (EG) and 1075 for the (C═O)—O group, where differences are observed in the appearance of intense and broad absorption in the 3373 cm⁻¹ region. This spectrum shows the specificity of PET resin, where the depolymerization products of PET could be observed.

In the spectrum obtained according to the present disclosure (FIG. 3), the infrared vibrational spectrum for the current PETpc resin, which is produced in the 2000-liter reactor, is shown. In this case, it is possible to observe the same behavior with or without additives, which shows that there is no difference when additives are added to the original resin, disclosed in patent No. BR102014029870-3. In the spectrum of FIG. 3, a complementation of the presence of pure ethylene glycol was made using a UNION brand pure commercial product to compare with the depolymerization products. It was possible to verify that the spectrum of pure ethylene glycol is quite different compared to the resin obtained in this disclosure, demonstrating that the resin contains a minimum percentage of ethylene glycol in its composition.

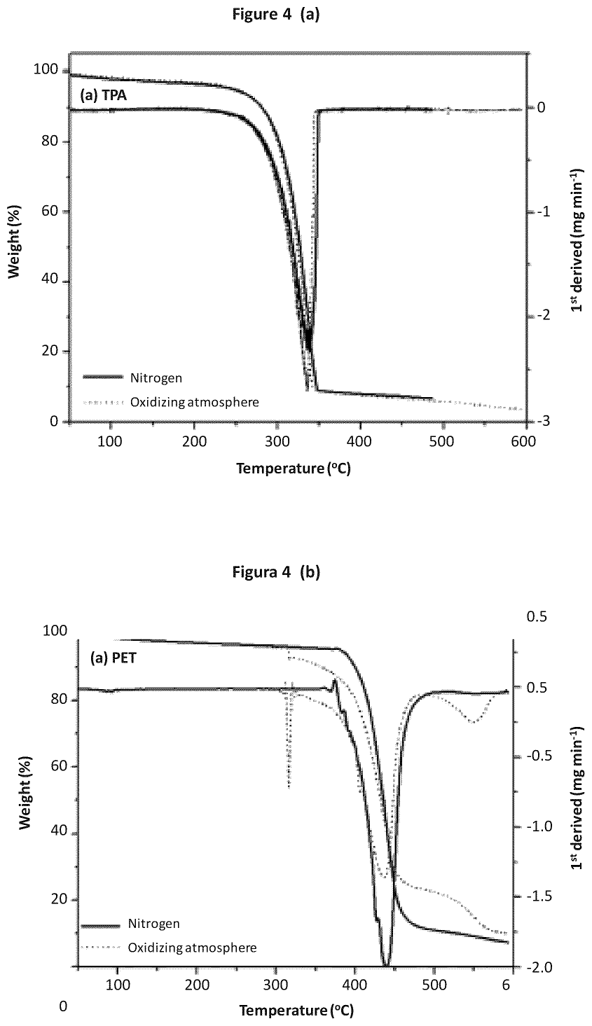

Thermal gravimetric analysis (TGA) was performed on a Shimadzu TG50 equipment, where 10 mg of the sample was used for the analysis, and the experiments were performed at a heating rate of 10° C. min-1, in an inert atmosphere of N₂ and oxidant (synthetic air) in a temperature range of 30 to 450° C., shown in FIG. 4 (a) and (b).

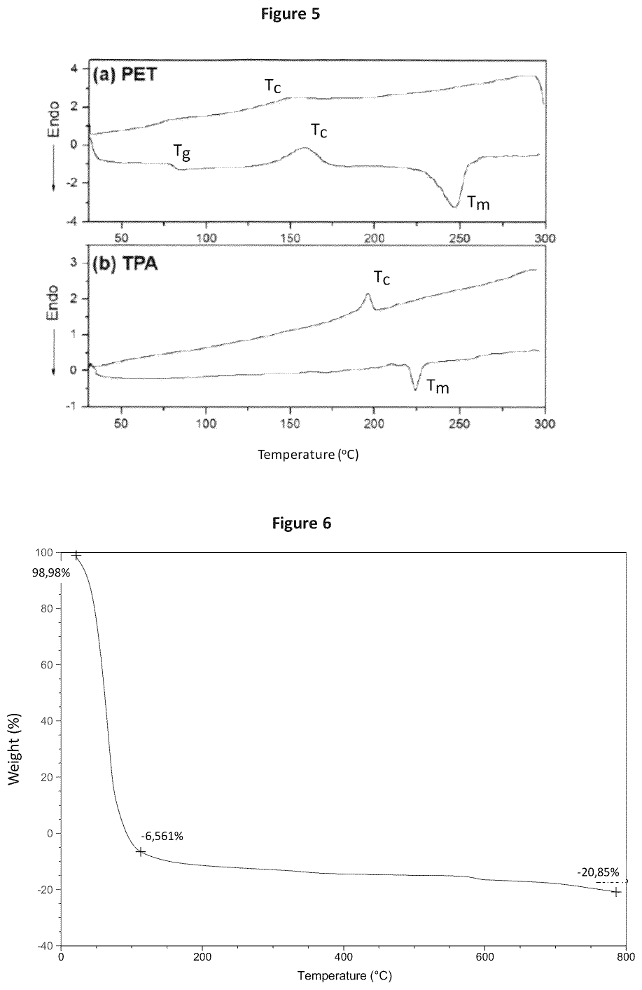

The Differential Scanning calorimetry (DSC) analysis was performed on a Q100 equipment (TA Instruments) controlled by Universal V4.7 software (TA Instruments). Data were obtained at heating and cooling rates of 10° C. per minute, with N₂ flow of 50 mL·min⁻¹, in the temperature range of 25 to 260° C., shown in FIGS. 5 and 6.

These results indicate that FIGS. 4(a) and (b) showed a range of thermal decomposition in the range of 250 to 350° C. However, PETpc showed greater thermal stability in the range of 310° C. to 600° C. in oxidizing atmosphere and 370° C. to 500° C. in inert atmosphere. The first mass loss is due to the presence of co-monomers such as diethylene glycol (DEG). The second mass loss is due to the presence of EG in the carbon chain of PETpc.

The DSC calorimetry results, FIGS. 4 and 5, pertain to the cooling and heating curves for PETpc and TPA, respectively.

The resin obtained originated from PETpc and, therefore, in its composition generated TPA after the depolymerization reaction, where the cooling curve does not have a defined crystallization peak (Tc), so the material has a slow crystallization kinetics, which grounds its high molar mass and the presence of copolymers that delay the crystallization process (the property that provides PET with the intended transparency during injection-blow processing), FIG. 4(a). The crystallization of PETpc is only completed when the second heating curve is performed, with a Tc=158° C. being observed, FIG. 4(a). The second heating curve showed a glass transition temperature, Tg=81° C., and melting temperature, Tm=247° C., for PETpc, agreeing with the works published by the group of Prof. De Paoli (Spinace, M. A.; De Paoli, M. A., J. Appl. Polym. Sci, 78, p. 20 (2001)). On the other hand, in FIG. 4(b), a peak of Tc=190° C. and Tm=225° C. was observed, which are characteristic for the TPA samples recovered in the depolymerization of PETpc and present products of resin preparation.

The Pour point of the resin was also determined, by manual method, in which the determined pour point value for PETUFES resin was −22° C., and this shows that the PET resin demonstrates good stability under critical conditions of low temperatures.

In an aspect, the depolymerization reaction described in step i) of the process of patent No. BR102014029870-3 is carried out in alkaline medium (NaOH 7.5 Mol/L) at a temperature of 100° C., in stainless steel reactor under temperature, pressure, time, and pH control.

The following examples are presented for a better understanding of preferred embodiments of patent No. BR102014029870-3 and this disclosure, which do not limit the scope of protection.

### Example 1: PETpc Depolymerization Reaction in the Presence of Surfactant CTAB

The depolymerization reaction under patent No. BR102014029870-3 is performed using PETpc previously cleaned with water and detergent and dried, subsequently ground into sizes of 1 cm×1 cm. PETpc fragments are added in a flat-bottomed flask with three joints with a capacity of 1000 mL, in the presence of 650 mL of the sodium hydroxide (NaOH) solution at a concentration of 7.5 mol/L and in the presence of 160 mL of the cationic surfactant CTAB, kept under constant stirring for 60 min at a temperature of 100° C.

After 60 min of the depolymerization reaction, concentrated hydrochloric acid was added for the neutralization of NaOH and precipitation of terephthalic acid monomer (TPA) along with sodium chloride salt (NaCl), which are removed by filtration. The remaining medium, containing ethylene glycol, is vacuum filtered and isopropyl alcohol is added to remove excess sodium chloride salt (NaCl). The obtained solution is again subjected to an evaporation process at 100° C. to remove excess water, obtaining 200 mL of intermediate resin.

### Example 2: Preparation of Dust Suppression Resin

To 200 mL of the intermediate resin obtained as described in Example 2 of patent No. BR102014029870-3 10 g of the product PVP K-90 (polyvinylpyrrolidone) was added in order to increase its final viscosity, obtaining the dust suppression resin described under patent No. BR102014029870-3, with density d=1.17 g/mL and viscosity of η=55.6 mm²/s or 55.6 cSt.

The results presented in Examples 1 and 2 prove the relevance and non-obviousness of patent No. BR102014029870-3, by demonstrating that the presence of the cationic surfactant in the reaction medium allows the reaction to obtain the intermediate resin to be carried out in a much shorter time (two hours according to Example 1) compared to the reaction time of the reaction without the presence of cationic surfactant (average time of six hours, according to the prior art). In addition to the significant reduction in reaction time, it is noteworthy that high purity products are obtained through the process described by this invention. FIG. 1 depicts schematics of the depolymerization chemical reactions of PETpc, with or without the use of surfactant CTAB as a catalyst.

Alternatively, still as part of the invention of patent No. BR102014029870-3, other components may be added to the dust suppression resin in order to make the resin more hydrophobic. As an example of an additive, but without limiting the understanding of the scope of this invention, lignin from vegetables (such as leaves and branches of trees) obtained by extraction with a mixture of 50% ethyl alcohol and 50% distilled water may be added.

### Example 3: PETpc Depolymerization Reaction in the Presence of Quaternary Ammonium Surfactant (Dodecyl Trimethylammonium Chloride)

The depolymerization reaction in this disclosure is carried out using PETpc previously cleaned with water and detergent and dried, subsequently ground. PETpc fragments are added in a reactor with a capacity of 2000 L, in the presence of 300 kg of sodium hydroxide (NaOH) solution at a concentration of 50% (w/v) and in the presence of 7 to 8 kg of the quaternary ammonium cationic surfactant (dodecyl trimethylammonium chloride), kept under constant stirring for one to three hours at a temperature of 97 to 103° C.

After the time of the depolymerization reaction, water was added to dissolve the terephthalic acid monomer (TPA). The remaining medium, containing intermediate resin, residual PETpc, and other impurities, is filtered and the solution obtained is subjected to a passive cooling process to room temperature, obtaining 6000 L of the intermediate resin.

### Example 4: Preparation of Dust Suppression Resin

To 3000 L of the intermediate resin obtained according to the description of Example 3 of the present disclosure, 4.5 kg of the hydrophilic substance (hydrogel) was added in order to increase its final viscosity, obtaining the dust suppression resin, with density d=1.17 g/mL and viscosity of η=55.6 mm²/s or 55.6 cSt.

The results presented in Examples 3 and 4 demonstrate that the presence of the cationic surfactant in the reaction medium allows the reaction to obtain the intermediate resin to be carried out in a much shorter time (two hours according to Example 3) compared to the reaction time of the reaction without the presence of cationic surfactant (average time of six hours, according to the prior art). FIG. 1 depicts the schematics of the depolymerization chemical reactions of PETpc, with or without the use of the cationic surfactant as catalyst.

Still as part of the present disclosure, other components may be added to the dust suppression resin in order to make the resin more hydrophobic. As an example of an additive, but without limiting the understanding of the scope of this invention, lignin from vegetables (such as leaves and branches of trees) obtained by extraction with a mixture of 50% ethyl alcohol and 50% distilled water may be added.

The present invention having been described in the form of its preferred embodiments and examples, it should be understood that the scope of the present invention covers other possible variations, this being limited only by the content of its claims, including possible equivalent modifications.

What is claimed is:

1. A method of preparing a dust suppression resin, comprising:
i) depolymerizing polyethylene terephthalate fragments in the presence of a cationic surfactant and in an alkaline medium to obtain a terephthalic acid monomer;
ii) diluting the terephthalic acid monomer with water to solubilize the terephthalic acid monomer to obtain a remaining medium;
iii) filtering the remaining medium to obtain a solution;
iv) subjecting of the solution to a passive cooling process to obtain an intermediate resin;
v) adding a viscosity-increasing agent selected from a group consisting of hydrophilic substances to the intermediate resin to obtain a dust suppression resin; and
vi) adding a hydrophobicity enhancing agent selected from a group consisting of lignin obtained from plants and polyethylene wax to the dust suppression resin.

2. The method of preparing the dust suppression resin of claim 1, wherein the cationic surfactant is quaternary ammonium.

3. The method of preparing the dust suppression resin of claim 1, wherein the hydrophobicity-enhancing agent is selected from lignin obtained from leaves and branches of trees.

4. The method of preparing the dust suppression resin of claim 1, wherein the dust suppression resin comprises characteristic functional groups at five absorption peaks in the infrared region of 3373, 1457, 1296, 1075, and 1037 cm¹, respectively.

5. A method of dust suppression, the method comprising using the dust suppression resin of claim 1 to inhibit particulate emission during ore mining or pelletizing processes.

6. A dust suppression resin made according to the method of claim 1.

7. A dust suppression resin made according to the method of claim 2.

8. A dust suppression resin made according to the method of claim 3.

9. A dust suppression resin made according to the method of claim 4.
